(19) United States
(12) Patent Application Publication
(10) Pub. No.: US 2022/0366402 A1
(43) Pub. Date: Nov. 17, 2022

(54) ELECTRONIC DOCUMENT VIEWER TO MOBILE WALLET COMMUNICATION

(71) Applicant: Well Fargo Bank, N.A., San Francisco, CA (US)

(72) Inventor: Joon Maeng, Newcastle, WA (US)

(21) Appl. No.: 15/669,471

(22) Filed: Aug. 4, 2017

(51) Int. Cl. G06Q 20/36; G06Q 20/38; G06Q 20/40

(52) U.S. Cl. CPC G06Q 20/367; G06Q 20/3829; G06Q 20/401; G06Q 2220/10

(57) ABSTRACT

Methods and systems are disclosed for processing an electronic document using a document viewer and a mobile wallet. The document viewer may receive an electronic document (e.g., an invoice) from a document sender, the electronic document capable of being printed or viewed on a display of the computing device in human-readable format. The document reviewer may receive a user request to obtain data related to the electronic document (e.g., a. payment token) from the mobile wallet. After receiving the user request, the document viewer may send a data request to the mobile wallet. After sending the data request, the document viewer may receive document-related data (e.g., the payment token) from the mobile wallet and send the document-related data payment token) to the document sender. The document sender (e.g., a merchant) may send the payment token to an issuer for payment processing.

### TECHNICAL FIELD

Embodiments described herein generally relate to systems and methods for communication between electronic document viewer applications and mobile wallet applications.

### BACKGROUND

Mobile wallet applications may be used to make payments. For example, a consumer may execute a mobile wallet application on a user computing device and use the mobile wallet application to provide payments to merchants for goods and services. Electronic document viewer applications may be used to view and print documents including invoices, for example.

### DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a diagram showing one example of an environment for communication between an electronic document viewer and a mobile wallet application.

FIG. 2 is a flowchart showing an example of a process flow that may be executed by a document viewer.

FIG. 3 is a timing diagram showing an example of payment process using a document viewer.

FIG. 4 is a timing diagram showing an example of payment process using a document viewer.

FIG. 5 illustrates an example display window of a document viewer.

FIG. 6 is a block diagram showing an example of a software architecture for a computing device.

FIG. 7 is a block diagram illustrating a computing device hardware architecture, within which a set or sequence of instructions can be executed to cause the machine to perform examples of any one of the methodologies discussed herein.

### DETAILED DESCRIPTION

A mobile wallet (also known as an electronic or digital wallet) refers to an application program executed by one or more computing devices (e.g., mobile devices such as a smartphone) and corresponding device memory which store and manage digital representations of elements (or items) typically found in a user's wallet or purse. These elements may comprise payment elements and non-payment elements. Payment elements are items which may be used in a financial transaction. Example payment elements managed by the digital wallet include digital representations of transaction cards, financial information, checking accounts, discount coupons, gift cards, subway passes, movie tickets, and so on. Example non-payment elements include digital representations of driver's licenses, passports, student ids, library cards, membership cards, insurance cards, and so on.

A mobile wallet application may allow an individual to use the stored information to pay for items (either in person or in e-commerce transactions), provide for identification (e.g., producing a driver's license), transfer money to others, access bank accounts, collect discount coupons, submit subway passes, and the like. Exemplary mobile wallets include but are not limited to WELLS FARGO WALLET™, CITI PAY™, STARBUCKS® APP, WALMART PAY™, APPLE PAY™, ANDROID PAY™, GOOGLE WALLET™, SAMSUNG PAY™, GYFT APP™, and peer-to-peer payment apps such as VENMO®, SQUARE CASH™ and TILT APP™,

An electronic document viewer (or document reviewer for short) refers to an application program executed by one or more computing devices (e.g., mobile devices such as a smartphone, portable and desktop computers, cloud servers, etc.) and corresponding device memory which displays electronic documents. Document viewers may also be used to print and edit and perform other functions on electronic documents, for example. An electronic document (e-document or document for short) refers to electronic media content that may be viewed by an appropriate document viewer in a human-readable format. Document viewers may use a proprietary format. Examples of such viewers include Microsoft Word, Microsoft Excel, Microsoft PowerPoint, and Adobe Acrobat systems. Electronic documents for such viewers are commonly referred to as .doc, .xls, .ppt and .pdf documents. Document viewers and e-documents may also use an open format such as HTML or OpenDocument for example. Document viewers for HTML, files include a number of different web browsers, including Google Chrome and Safari for example. Document viewers differ from mobile wallet applications in many ways including, for one, that document viewers may not manage and/or store payment elements.

It is common for merchants (including credit card companies) to deliver invoices to customers as electronic documents. To pay an invoice, a customer may print the invoice or remittance page and print their payment information (e.g., credit card number, etc.) on a remittance page and return the page with their payment information to the merchant by mail. In other instances, a customer may use a third party bill pay system to pay the invoice. The use of mail and third party bill pay systems exposes the customer's payment information to risk from theft or fraud. There is also typically a time delay for the customer to respond to the invoice thus delaying payment and possibly resulting in penalties. There is also risk to the merchant. For example, there is the risk that the payment information being provided by a customer is not accurate, or worse, was fraudulently obtained.

The disclosure herein provides methods and systems for communication between an electronic document viewer application and a mobile wallet application. The e-document viewer application and mobile wallet application may be separate applications operating on the same computer (e.g., processor) or on different computers (e.g., different processors). The document viewer may, for example, receive an electronic document such as an invoice requesting payment from a sender (e.g., a merchant) and communicate with the mobile wallet in a secure manner to obtain a payment token from the mobile wallet for paying the invoice. The document viewer may securely send the payment token (e.g., embedded in the electronic document) to the sender (e.g., a merchant) which can in turn send the payment token to a payment processor to obtain payment. In this manner, a payment for the invoice may be securely and efficiently processed using a document viewer communicating with a mobile wallet and the c-document sender (e.g., a merchant). These are among other features of the examples provided herein.

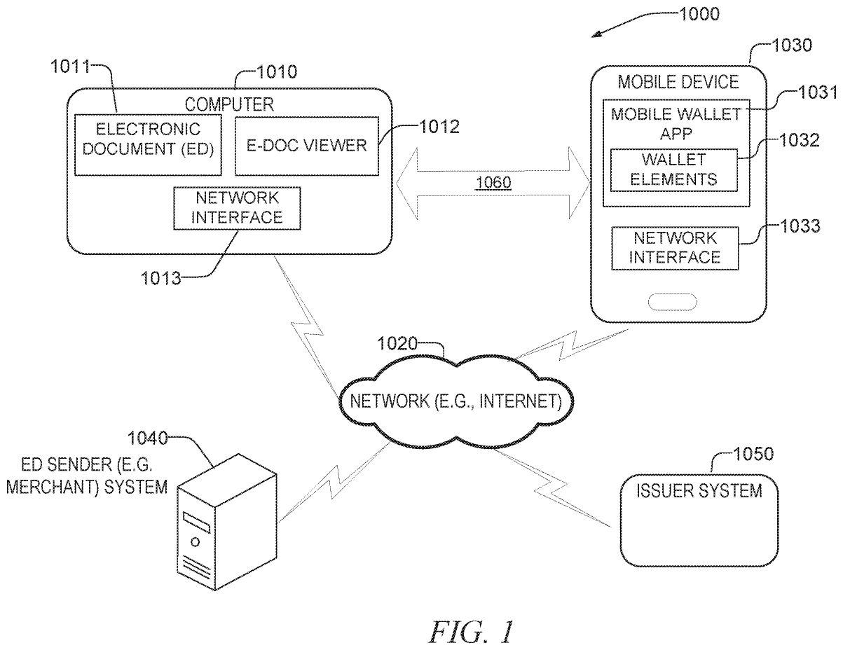

FIG. 1 illustrates an example environment 1000 for communication between a document viewer and a mobile wallet to, for example, process a payment related to an e-document. The example environment 1000 includes an electronic document viewer 1012 executing on a computer 1010 such as a laptop or desktop computer. The computer 1010 includes an electronic document 1011 capable of being processed (e.g., opened, displayed, and edited) by the document viewer 1012. The document 1011 may be received from an electronic document sender 1040 over a network 1020 and stored in memory (not shown). The computer 1010 further includes a network interface 1013 for communicating over the network 1020.

The example environment 1000 further includes a mobile wallet application 1031 (sometimes, simply referred to as a mobile wallet) operating on a mobile device 1030 such as a smart phone or smart watch. The mobile wallet 1031 includes one or more elements such as payment elements (e.g., credit or debit cards) and non-payment elements (e.g., identification cards). The mobile device 1030 also includes a network interface 1033 for communicating over the network 1020.

The environment can further include one or more networks such as the network 1020 over which the various systems communicate using network interfaces. The network 1020 can include local-area networks (LAN), wide-area networks (WAN), wireless networks (e.g., 802.11 or cellular network), the Public Switched Telephone Network (PSTN) network, ad hoc networks, cellular, personal area networks or peer-to-peer (e.g., Bluetooth®, Wi-Fi Direct), or other combinations or permutations of network protocols and network types. The network 140 can include a single local area network (LAN) or wide-area network (WAN), or combinations of LAN's or WAN's, such as the Internet.

The document viewer 1012 may communicate with the mobile wallet 1031 over a direct connection 1060 such as by Bluetooth, or in other examples, by near field communication (NFC), WIFI, or wired connection such as USB. While a direct connection may provide more security, the document viewer 1012 and mobile wallet 1031 may alternatively or additionally communicate over the network 1020. In other environments, the document viewer 1012 and mobile wallet 1031 may reside on a common computing device such as a mobile phone and may communicate with one another using, for example, API calls over the device's communication bus.

In a payment processing example, the computer 1010 may receive the electronic document 1011 (e.g., an invoice) from the document sender 1040 (e.g., a merchant) over the network 1020. The document viewer 1012 may open the e-document 1011 and establish a connection with the mobile wallet 1031 using the direct connection 1060 (e.g., Bluetooth). The document viewer 1012 may send a request to the mobile wallet 1031 for a payment token from a payment element 1032 of the mobile wallet. The request may include for example an amount for a payment on the invoice. The mobile wallet 1031 may respond by sending a payment token over the path 1060 that is received by the document viewer 1012. The viewer 1012 may provide the payment token to the document sender 1040 (e.g., merchant) which may in turn provide the token to an issuer 1050 over network 1020 for payment processing. The issuer 1050 may include one or more computing systems used to process (e.g., approve payments) and may be part of or affiliated with a financial institution such as a bank, a wallet service provider and/or a card processing network such as Visa. The payment token may, for example, be provided by the viewer 1012 to sender 1040 by embedding the token in the electronic document 1011 using public key encryption and sending the revised e-document with the payment token to the sender 1040.

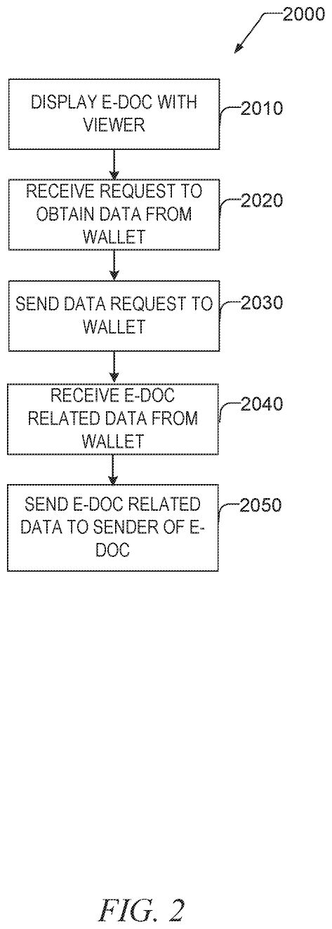

FIG. 2 is a flowchart showing an example of a process flow 2000 that may be executed by a document viewer for communicating with a mobile wallet to obtain data related to an electronic document. The e-document may, for example, be an invoice having a remittance page for a payment or a form including a request for identification. The document viewer and mobile wallet may operate on the same or separate computing devices. At 2010, the document viewer may display an electronic document (or a portion thereof) received from a sender. The viewer may retrieve the e-document from a local storage location (e.g., computing device memory) or remote storage location (e.g., cloud server) and display the e-document in a display window. The electronic document may include a unique sender identifier which can be used to verify the legitimacy of sender by the document viewer or the computing system on which it operates. The e-document may further include the public key of the sender or the document viewer may obtain the public key from a keychain for example.

At 2020, the document viewer may receive a user request to obtain data related to the electronic document from a mobile wallet. The request may, for example, be the selection of an input (e.g., a menu item, button or icon) for selection of the mobile wallet. The input may be displayed in a document viewer window along with at least a portion of the e-document. In some examples, the document viewer may search for available mobile wallets in response to receiving the user request, display a menu of available mobile wallets and receive a user selection of the mobile wallet from the menu. In response the selection of a mobile wallet, the document viewer may display one or more elements (e.g., payment and/or non-payment elements) available on the mobile wallet and receive a user selection of one or more of the elements for obtaining the document-related data.

The document-related data may be any data available on the mobile wallet and related to the e-document. The data may be contained in payment elements or non-payment elements. The data may, for example, be payment data such as a payment token or payment account for paying an invoice, or non-payment data such as an insurance card for an insurance claim, a passport for booking airfare, as just a few examples. The data may further include data from more than one element in the mobile wallet. For example, the document-related data may include a payment token and a form of identification such as a passport or a driver's license or an airline ticket and a form of identification.

At 2030, after the user request, the document viewer may send a data request to the mobile wallet. Prior to or as part of the request, the document viewer may establish a connection with the mobile wallet. In some examples, the document viewer and mobile wallet may be paired prior to receiving the e-document. In some examples, a user may configure the document viewer and mobile wallet so that a default payment element is provided. At 2040, the document viewer may receive the document-related data (e.g., payment token and/or ID) from the mobile wallet. The sending and receiving of the data request may take place over a direct connection path such as Bluetooth. In some examples, the e-document viewer and a mobile device containing one or more mobile wallets may establish a connection before a user selects the mobile wallet. In other cases, the e-document viewer and mobile device may connect after a user selects a mobile wallet.

At 2050, the document viewer may send the document-related data to the document sender. The document viewer may, for example, combine the document-related data with the electronic document to produce a revised e-document and send the revised e-document to the document sender. This may include embedding the document-related data in the e-document and encrypting the e-document using a public key of the document sender, for example.

Where the document-related data is a payment token, the document sender (e.g., a merchant), having received the payment token from the document viewer, may send the payment token to an issuer such as a financial institution, wallet service provider and/or processing network to process payment with the token. Where the payment token is embedded in a revised e-document, the document sender (e.g., merchant) may decrypt the e-document with its private key prior to sending the payment token the issuer. Upon completion of the payment, the document viewer may receive confirmation of the payment to the sender from an issuer. Where the document sender (e.g., merchant) sends the payment token upon or shortly after receiving it from the e-document viewer, a confirmation may be displayed to the user while the electronic document is still open in the window of the document viewer. An email confirmation may also be sent to the user's email address.

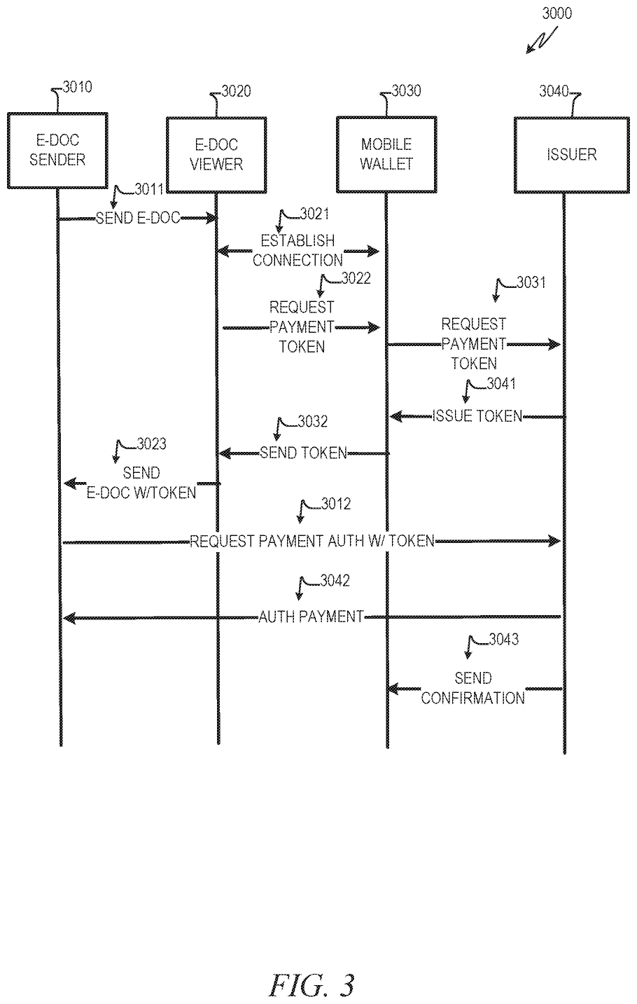

FIG. 3 is a timing diagram 3000 showing one example of payment process using a document viewer 3020 communicating with a mobile wallet 3030. At 3011, an electronic document (ED) sender 3010 may send an electronic document such as an invoice. The document may be sent in a number of manners. It may be sent directly to the viewer over an established connection with the sender. It may be sent as an attachment to an email which may be opened by the document viewer. In another example, it may be sent to a file location accessible by the document viewer.

The document viewer 3020 may open the electronic document and display it in a window of the document viewer. At 3021, the document viewer may establish a connection with a mobile wallet 3030 over a personal communication path such as Bluetooth using, for example, an API (application program interface). In some examples, the e-document may include a mobile wallet tag (e.g., in metadata) which may be read by the e-document viewer to automatically establish a connection with a mobile wallet or automatically display an input for selection a mobile wallet. In some examples, the e-document may include a link to select a mobile wallet for payment processing.

At 3022, the document viewer may request a payment token from the mobile wallet. The document viewer may receive a list of available mobile wallets for selection of the mobile wallet 3030 by a user. In other cases, a user may pre-configure a default payment element for the document viewer. Once selected, the document viewer may display the mobile wallet or contents thereof in a window within the document viewer and then receive a selection of a payment element from the mobile wallet 3030 for obtaining a payment token. In other cases, with the selection of the mobile wallet 3030, the document viewer may launch the mobile wallet 3030 in a separate window and receive a selection of the payment element.

At 3031, after a user selects a payment element in the mobile wallet, the mobile wallet 3030 may request a payment token from an issuer 3040 (e.g., a financial institution, wallet service provider and/or processing network) of the payment element. The token request may include an amount (e.g., a bill payment amount) and an identifier of the payment element, the mobile wallet 3030 and/or the mobile device (not shown) on which the mobile wallet executes. The issuer 3040 may verify the request (e.g., verify the identity of the requester and the balance of a financial account associated with the payment element) and may issue a payment token to the mobile wallet securely at 3041. The payment token may be an object that includes payment credentials that may be used to pay the requested amount. The object may contain one or more of the issuer's ID, mobile wallet ID, total amount, payment account information, and other information that may prevent fraudulent use. The object may also include usage limitations. The mobile wallet 3030 may send the payment token to the document viewer as shown at 3032. This may be done over the same personal communication path using an API, for example.

The document viewer 302.0 may embed the payment token in the electronic document securely (not shown). This may be done using the public key of the document sender as discussed above. The document viewer 3020 may send the e-document embedded with the payment token to the e-document sender as shown at 3023. The address of the e-document sender may be included in the e-document and read by the document viewer. Including the address in the e-document and embedding the payment token in the e-document in an encrypted manner increases security of the payment. Moreover, by embedding the payment token with the e-document and returning the document to the sender, association of the payment with the invoice can be more easily tracked by the sender (e.g., a merchant).

At 3012, the e-document sender 3010 may send a request to clear the payment token to the issuer 3040. The may include sending the payment token and other information such as a merchant identifier or product/service information to the issuer 3040. This may be done upon receipt of the payment token or at a later time (e.g., during batch processing of a number of payments). The issuer 3040 may authorize payment (e.g., verify and clear the payment token) and inform the e-document sender of the authorization as shown at 3042. The issuer 3040 may inform completion of the transaction to the mobile wallet 3030 as shown at 3043. The mobile wallet 3030 may also send a message to the document viewer informing the viewer of the completion of the transaction. In some cases, where payment is processed in near real time, the document viewer may show the completion of the payment in a window while the e-document remains displayed.

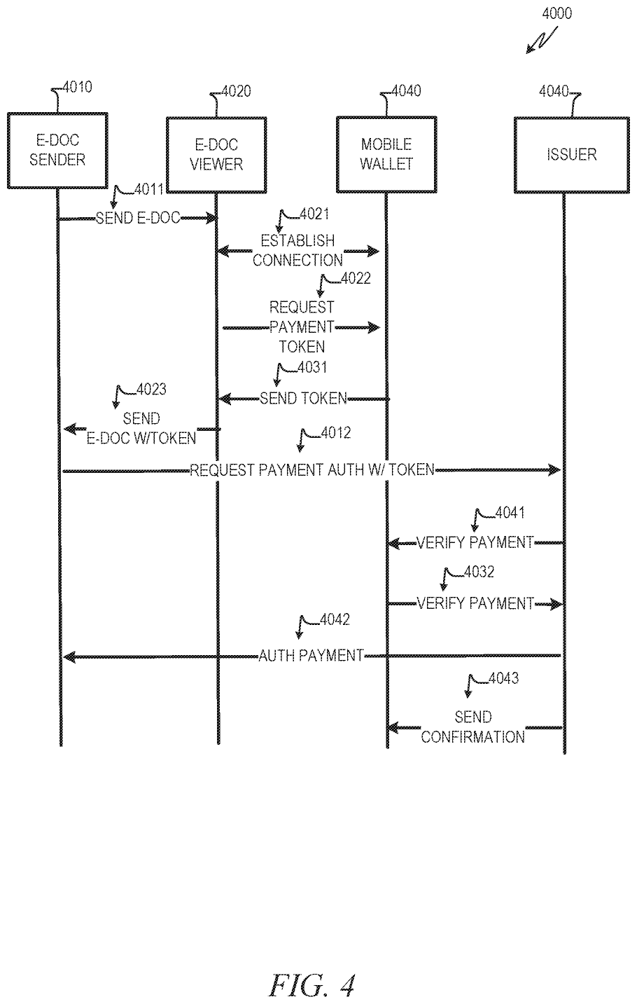

FIG. 4 is a timing diagram 4000 showing an example of payment process using a document viewer 4020 communicating with a mobile wallet 4030. This diagram differs from diagram 3000 in that the mobile wallet 4030 generates a payment token in response to a request from a document viewer 4020 rather than relaying a request to an issuer and receiving a token from an issuer as in diagram 3000, In timing diagram 4000, as illustrated at 4011, 4021 and 4022, the electronic document (ED or e-document) sender 4010 may send an electronic document to the document viewer 4020, the document viewer 4020 may establish a connection with the mobile wallet 4030 and may request a payment token from the mobile wallet 4030. This may all be performed in a similar manner as discussed above, for example, with regard to timing diagram 3000.

In response to the payment token request, the mobile wallet 4030 may create a payment token for the transaction and send the payment token to the document viewer at 4031. The payment token may be sent over a personal communication path such as Bluetooth. The transmission may be encrypted (e.g., using a public key of the document viewer). The payment token may comprise payment credentials that may be used only one time for the specified transaction only. The payment credentials may be encrypted data (e.g., using the public key of an issuer) including biller ID, transaction number, onetime payment credentials, and other information that may be used by an issuer to verify its authenticity. The payment credentials may be generated by the mobile wallet 4030 by, for example, using a limited use cryptogram provided by the issuer at an earlier time. The e-document viewer may send the payment token to the e-document sender 4010 which may send it to the issuer 4040 for authorization as shown at 4023, 4012, 4042, and 4043) in a similar fashion as discussed above, for example, with regard to timing diagram 3000. Optionally, at 4041 and 4032, the issuer 4040 may verify the payment authorization with the mobile wallet 4040 and await receipt of verification from the mobile wallet 4040 prior to authorizing payment at 4042.

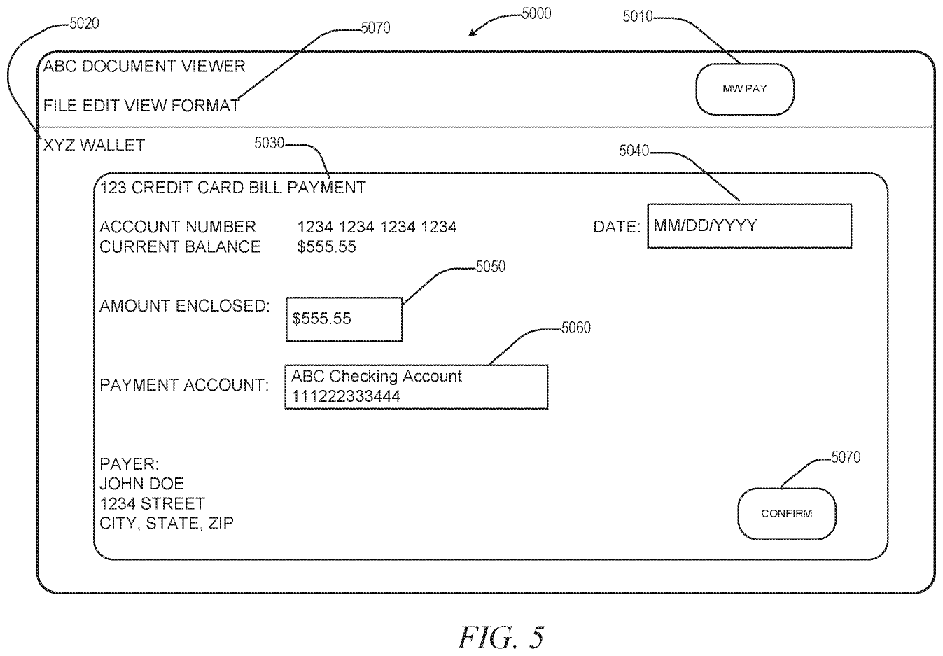

FIG. 5 illustrates an example display window of a document viewer 5000 operating on computing device. The document viewer 5000 may include a menu bar 5070 having input tabs for a user to open, view, edit, print, save, or perform other functions with an electronic document. The electronic document may be a monthly statement for a credit card (e.g., 123 credit card) and the document viewer 5000, in this example, displays a bill payment page 5030 from the monthly statement in a window of the document viewer 5000.

The document viewer 5000 may further display an input 5010 (e.g., button) that a user may select (e.g., click or touch) to pay the invoice with a mobile wallet. The input 5010 may be a standard button on the document viewer 5010 or may be hidden and displayed only with appropriate e-documents. For example, an e-document may include a payment tag that may be read by the document viewer to determine whether to display input 5010. The input 5010 may be an extension for the document viewer, such as Adobe extension or a browser extension.

The document viewer 5000 may detect a user selection of input 5010 to obtain a payment token from a mobile wallet. A user may use the document viewer 5000 to select a mobile wallet and a payment element as discussed above. For example, the document viewer 5000 may display a list of available wallets and the selected wallet at 5020 and also display a list of available payment elements and the selected payment element at 5060. The document viewer 5000 may use an API to communicate with the operating system of the computing device on which the viewer 5000 executes and request to establish a communication with a mobile wallet which may be within Bluetooth pairing range. The computing device may search for a mobile device such as smartphone or smartwatch with a mobile wallet and request to establish connection with the mobile wallet. In some examples, the mobile wallet or document viewer may prompt the user for a PIN or other identification to accept the connection between the document viewer and the mobile wallet.

Once a communication is established, the document viewer may show the connected mobile wallet at 5020. The document viewer may populate or receive user input providing an amount 5050 and date 5040 for a payment request. The document viewer 5000 may display the selected payment element 5060 of the connected mobile wallet, To confirm a payment, the document viewer may detect a user input at 5070 confirming a payment request and may then send a request to the mobile wallet for a payment token to make a bill payment on the invoice. The payment token may be received by the document viewer and provided to the sender of the e-document as discussed above. In addition, the user may save the e-document with the payment token or send it to the document sender by, for example, providing a link to the document or attaching it to an email.

In another example of c-document viewer and mobile wallet payment processing, an e-document viewer may send payment-related data (e.g., a reference or invoice number, amount and recipient) to a mobile wallet, and the mobile wallet may receive the data, generate a payment package and send the payment package to a payment process for making payment. The c-document viewer may establish a connection with the mobile wallet in any of the manners discussed above. Upon opening an e-document, the viewer may extract the payment-related data and send the data to the selected mobile wallet upon a user's confirmation, for example.

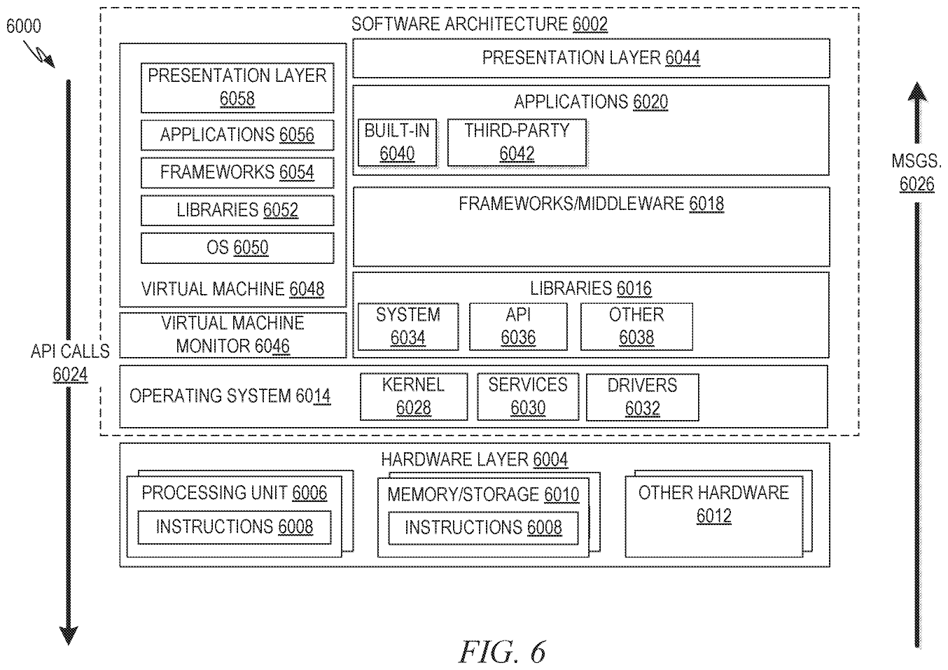

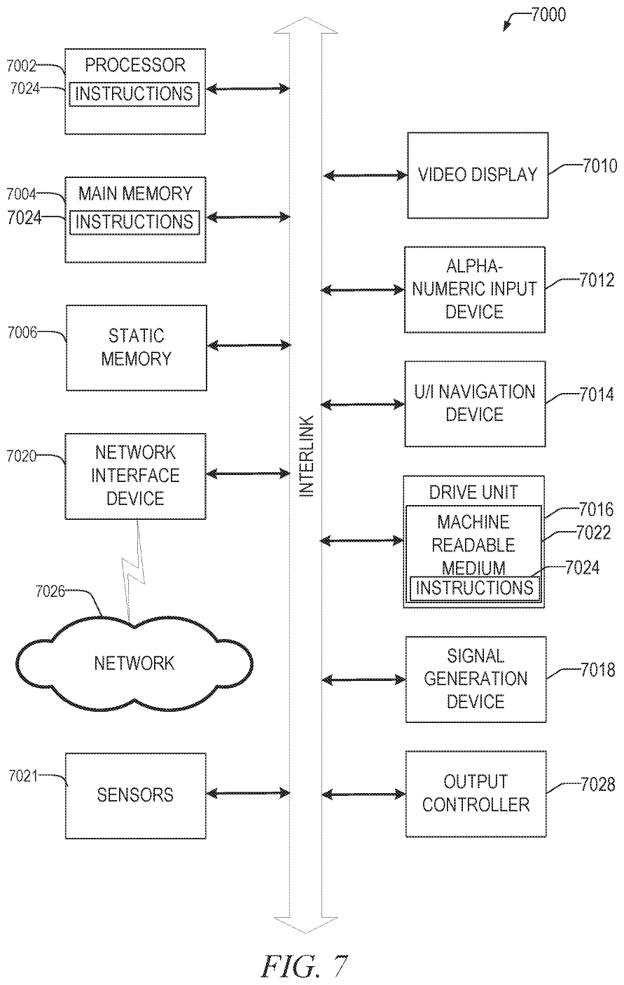

FIG. 6 is a block diagram 6000 showing one example of a software architecture 6002 for a computing device. The architecture 6002 maybe used in conjunction with various hardware architectures, for example, as described herein. FIG. 6 is merely a non-limiting example of a software architecture 6002 and many other architectures may be implemented to facilitate the functionality described herein. A representative hardware layer 6004 is illustrated and can represent, for example, any of the above referenced computing devices. In some examples, the hardware layer 6004 may be implemented according to the architecture 7000 of FIG. 7.

The representative hardware layer 6004 comprises one or more processing units 6006 having associated executable instructions 6008. Executable instructions 6008 represent the executable instructions of the software architecture 6002, including implementation of the methods, modules, components, and so forth of FIGS. 1-5. Hardware layer 6004 also includes memory and/or storage modules 6010, which also have executable instructions 6008. Hardware layer 6004 may also comprise other hardware as indicated by other hardware 6012, which represents any other hardware of the hardware layer 6004, such as the other hardware illustrated as part of hardware architecture 7000.

In the example architecture of FIG. 6, the software 6002 may be conceptualized as a stack of layers where each layer provides particular functionality. For example, the software 6002 may include layers such as an operating system 6014, libraries 6016, frameworks/middleware 6018, applications 6020, and presentation layer 6044. Operationally, the applications 6020 and/or other components within the layers may invoke application programming interface (API) calls 6024 through the software stack and receive a response, returned values, and so forth illustrated as messages 6026 in response to the API calls 6024. The layers illustrated are representative in nature and not all software architectures have all layers. For example, some mobile or special purpose operating systems may not provide a frameworks/middleware layer 6018, while others may provide such a layer Other software architectures may include additional or different layers.

The operating system 6014 may manage hardware resources and provide common services. The operating system 6014 may include, for example, a kernel 6028, services 6030, and drivers 6032. The kernel 6028 may act as an abstraction layer between the hardware and the other software layers. For example, the kernel 6028 may be responsible for memory management, processor management (e.g., scheduling), component management, networking, security settings, and so on. The services 6030 may provide other common services for the other software layers. In some examples, the services 6030 include an interrupt service. The interrupt service may detect the receipt of a hardware or software interrupt and, in response, cause the architecture 6002 to pause its current processing and execute an ISR. when an interrupt is received. The ISR may generate the alert, for example, as described herein.

The drivers 6032 may be responsible for controlling or interfacing with the underlying hardware. For instance, the drivers 6032 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 6016 may provide a common infrastructure that may be utilized by the applications 6020 and/or other components and/or layers. The libraries 6016 typically provide functionality that allows other software modules to perform tasks in an easier fashion than to interface directly with the underlying operating system 6014 functionality (e.g., kernel 6028, services 6030 and/or drivers 6032). The libraries 6016 may include system libraries 6034 (e.g., C standard library) that may provide functions such as memory allocation functions, string manipulation functions, mathematic functions, and the like. In addition, the libraries 6016 may include API libraries 6036 such as media libraries (e.g., libraries to support presentation and manipulation of various media format such as MPEG4, H.264, MP3,AAC, AMR, JPG, PNG), graphics libraries (e.g., an OpenGL, framework that may be used to render 2D and 9D in a graphic content on a display), database libraries (e.g., SQLite that may provide various relational database functions), web libraries (e.g., WebKit that may provide web browsing functionality), and the like. The libraries 6016 may also include a wide variety of other libraries 6038 to provide many other APIs to the applications 6020 and other software components/modules.

The frameworks 6018 (also sometimes referred to as middleware) may provide a higher-level common infrastructure that may be utilized by the applications 6020 and/or other software components/modules. For example, the frameworks 6018 may provide various GUI functions, high-level resource management, high-level location services, and so forth. The frameworks 6018 may provide a broad spectrum of other APIs that may be utilized by the applications 6020 and/or other software components/modules, some of which may be specific to a particular operating system or platform.

The applications 6020 include built-in applications 6040 and/or third-party applications 6042. Examples of representative built-in applications 6040 may include, but are not limited to, a contacts application, a browser application, a book reader application, a location application, a media application, a messaging application, and/or a game application. Third-party applications 6042 may include any of the built-in applications 6040 as well as a broad assortment of other applications. In a specific example, the third-party application 6042 (e.g., an application developed using the Android™ or iOS™ software development kit (SDK) by an entity other than the vendor of the particular platform) may be mobile software running on a mobile operating system such as iOS™, Android™, Windows® Phone, or other user computing device operating systems. In this example, the third-party application 6042 may invoke the API calls 6024 provided by the mobile operating system such as operating system 6014 to facilitate functionality described herein.

The applications 6020 may utilize built-in operating system functions (e.g., kernel 6028, services 6030 and/or drivers 6032), libraries (e.g., system 6034, APIs 6036, and other libraries 6038), frameworks/middleware 6018 to create user interfaces to interact with users of the system. Alternatively, or additionally, in some systems, interactions with a user may occur through a presentation layer, such as presentation layer 6044. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 6, this is illustrated by virtual machine 6048. A virtual machine creates a software environment where applications/modules can execute as if they were executing on a hardware computing device. A virtual machine is hosted by a host operating system (operating system 6014) and typically, although not always, has a virtual machine monitor 6046, which manages the operation of the virtual machine 6048 as well as the interface with the host operating system (i.e., operating system 6014). A software architecture executes within the virtual machine 6048 such as an operating system 6050, libraries 6052, frameworks/middleware 6054, applications 6056, and/or presentation layer 6058. These layers of software architecture executing within the virtual machine 6048 can be the same as corresponding layers previously described or may be different.

FIG. 7 is a block diagram illustrating a computing device hardware architecture 7000, within which a set or sequence of instructions can be executed to cause the machine to perform examples of any one of the methodologies discussed herein. For example, the architecture 7000 may execute the software architecture 6000 described with respect to FIG. 6. The architecture 7000 may operate as a standalone device or may be connected (e g , networked) to other machines. In a networked deployment, the architecture 7000 may operate in the capacity of either a server or a client machine in server-client network environments, or it may act as a peer machine in peer-to-peer (or distributed) network environments. The architecture 7000 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 7000 includes a processor unit 7002 comprising at least one processor (e.g., a central processing unit (CPU), a graphics processing unit (GPU) or both, processor cores, compute nodes, etc.). The architecture 7000 may further comprise a main memory 7004 and a static memory 7006, which communicate with each other via a link 7008 (e.g., bus) The architecture 7000 can further include a video display unit 7010, an alphanumeric input device 7012 (e.g., a keyboard), and a UI navigation device 7014 (e.g., a mouse). In some examples, the video display unit 7010, input device 7012, and UI navigation device 7014 are incorporated into a touch screen display. The architecture 7000 may additionally include a storage device 7016 (e.g., a drive unit), a signal generation device 7018 (e.g., a speaker), a network interface device 7020, and one or more sensors (not shown), such as a GPS sensor, compass, accelerometer, or other sensor.

In some examples, the processor unit 7002 or other suitable hardware component may support a hardware interrupt. In response to a hardware interrupt, the processor unit 7002 may pause its processing and execute an TSR, for example, as described herein.

The storage device 7016 includes a machine-readable medium 7022 on which is stored one or more sets of data structures and instructions 7024 (e.g., software) embodying or utilized by any one or more of the methodologies or functions described herein. The instructions 7024 can also reside, completely or at least partially, within the main memory 7004, static memory 7006, and/or within the processor unit 7002 during execution thereof by the architecture 7000, with the main memory 7004, static memory 7006, and the processor unit 7002 also constituting machine-readable media. Instructions stored at the machine-readable medium 7022 may include, for example, instructions for implementing the software architecture 1302, instructions for executing any of the features described herein, etc.

While the machine-readable medium 7022 is illustrated in an example to be a single medium, the term “machine-readable medium” can include a single medium or multiple media (e.g., a centralized or distributed database, and/or associated caches and servers) that store the one or more instructions 7024. The term “machine-readable medium” shall also be taken to include any tangible medium that is capable of storing, encoding, or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 7024 can further be transmitted or received over a. communications network 7026 using a transmission medium via the network interface device 7020 utilizing any one of a number of well-known transfer protocols (e.g., HTTP). Examples of communication networks include a LAN, a WAN, the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. §1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A computer-implemented method comprising:
displaying, by a first computing device using a document viewer application executing on the first computing device, at least part of an electronic invoice, the electronic invoice having been received by the first computing device from a merchant computing device associated with a merchant, the electronic invoice being viewable on a display of the first computing device in a human-readable format;
receiving, by the first computing device via the document viewer application, a user request to obtain, from a mobile wallet application executing on a second computing device, data related to the electronic invoice;
after receiving the user request, establishing, by he first computing device, a local wireless data connection with the second computing device;
sending, by the first computing device via the local wireless data connection, a data request to the mobile wallet application, the data request requesting a payment token for a transaction related to the electronic invoice;
after sending the data request, receiving, by the first computing device via the local wireless data connection into the document viewer application, document-related data from the mobile wallet application, the document-related data being related to the electronic invoice, the document-related data including the payment token, the payment token being a data object that includes payment credentials that are usable only one time and only for the transaction related to the electronic invoice;
combining, by the first computing device using the document viewer application, the document-related data with the electronic invoice at least in part by embedding the payment token in the electronic invoice to produce a revised electronic invoice, the embedding comprising encrypting the revised electronic invoice using a public encryption key of the merchant; and
sending, by the first computing device, the encrypted revised electronic invoice to the merchant computing device for use by the merchant of the payment credentials in connection with the transaction.

2. The method of claim 1, wherein displaying the at least part of the electronic invoice includes displaying a button for selecting the mobile wallet for requesting the document-related data.

3-4. (canceled)

5. The method of claim 1, further including searching, by the first computing device, for available mobile wallet applications in response to receiving the user request via the document viewer application.

6. (canceled)

7. The method of claim 1, wherein the document-related data further includes either or both of a payment-account identifier and non-payment-related data.

8-9. (canceled)

10. The method of claim 1, further including the first computing device displaying, using the document viewer application, a menu of available wallet applications and receiving, via the document viewer application, a user selection of the mobile wallet application from the menu.

11. The method of claim 10, further including the first computing device displaying, using the document viewer application, one or more payment elements available in the mobile wallet application, and receiving a user selection of one of the one or more payment elements for providing the payment token.

12. The method of claim 11, further including receiving, by the first computing device, a confirmation of a payment made to the merchant using the payment token.

13. A first computing device comprising:
a document viewer application;
at least one hardware processor; and
at least one storage device comprising instructions executable by the at least one hardware processor to cause the at least one hardware processor to execute the document viewer application and to perform operations comprising:
displaying, using the document viewer application, at least part of an electronic invoice, the electronic invoice having been received by the first computing device from a merchant computing device associated with a merchant, the electronic invoice being viewable on a display of the first computing device in a human-readable format;
receiving, via the document viewer application, a user request to obtain, from a mobile wallet application executing on a second computing device, data related to the electronic invoice;
after receiving the user request, establishing, by the first computing device, a local wireless data connection with the second computing device;
sending, via the local wireless data connection, a data request to the mobile wallet application, the data request requesting a payment token for a transaction related to the electronic invoice;
after sending the data request, receiving, via the local wireless data connection into the document viewer application, document-related data from the mobile wallet application, the document-related data being related to the electronic invoice, the document-related data including the payment token, the payment token being a data object that includes payment credentials that are usable only one time and only for the transaction related to the electronic invoice;
combining, using the document viewer application, the document-related data with the electronic invoice at least in part by embedding the payment token in the electronic invoice to produce a revised electronic invoice, the embedding comprising encrypting the revised electronic invoice using a public encryption key of the merchant; and
sending the encrypted revised electronic invoice to the merchant computing device for use by the merchant of the payment credentials in connection with the transaction.

14-15. (canceled)

16. The first computing device of claim 13, the operations further comprising:
receiving, via the document viewer application, a user selection of the mobile wallet application from a menu displayed using the document viewer application;
displaying, using the document viewer application, one or more payment elements available in the mobile wallet application; and
receiving a user selection of one of the payment elements for obtaining the payment token.

17. A non-transitory machine-readable medium comprising instructions executable by at least one hardware processor of a first computing device to cause the at least one hardware processor to perform operations comprising:
displaying, using a document viewer application executing on the at least one hardware processor, at least part of an electronic invoice, the electronic invoice having been received by the first computing device from a merchant computing device associated with a merchant, the electronic invoice being viewable on a display of the first computing device in a human-readable format;
receiving, via the document viewer application, a user request to obtain, from a mobile wallet application executing on a second computing device, data related to the electronic invoice;
after receiving the user request, establishing, by the first computing device, a local wireless data connection with the second computing device;
sending, via the local wireless data connection, a data request to the mobile wallet application, the data request requesting a payment token for a transaction related to the electronic invoice;
after sending the data request, receiving, via the local wireless data connection into the document viewer application, document-related data from the mobile wallet application, the document-related data being related to the electronic invoice, the document-related data including the payment token, the payment token being a data object that includes payment credentials that are usable only one time and only for the transaction related to the electronic invoice;
combining, by the first computing device using the document viewer application, the document-related data with the electronic invoice at least in part by embedding the payment token in the electronic invoice to produce a revised electronic invoice, the embedding comprising encrypting the revised electronic invoice using a public encryption key of the merchant; and
sending the encrypted revised electronic invoice to the merchant computing device for use by the merchant of the payment credentials in connection with the transaction.

18-19. (canceled)

20. The non-transitory machine-readable medium of claim 17, the operations further comprising:
receiving, via the document viewer application, a user selection of the mobile wallet from a menu displayed using the document viewer application;
displaying, using the document viewer application, one or more payment elements available in the mobile wallet; and
receiving a user selection of one of the payment elements for obtaining the payment token.
